(19) United States
(12) Patent Application Publication
(10) Pub. No.: US 2006/0092470 A1
(43) Pub. Date: May 4, 2006

(54) Printing apparatus and computer readable medium

(75) Inventor: Akihiro Yamada, Nagoya-shi (JP)

Correspondence Address: OLIFF & BERRIDGE, PLC, P.O. BOX 19928, ALEXANDRIA, VA, 22320, US

(73) Assignee: Brother Kogyo Kabushiki Kaisha, Nagoya-shi (JP)

(21) Appl. No.: 11/256,171

(22) Filed: Oct. 24, 2005

(30) Foreign Application Priority Data
Oct. 22, 2004 (JP) 2004-307946

(51) Int. Cl. G06K 15/00

(52) U.S. Cl. 358/1.16

(57) ABSTRACT

When print data such as PDL data is received from a host, it is determined whether an available space corresponding to a capacity required for analyzing the print data exists, and the space corresponding to the capacity is secured as a print data analyzing memory area when the available space exists. Subsequently, it is determined whether an available space corresponding to a capacity required for developing image data exists, and a capacity, which is not less than 1 MB and is capable of being secured at the maximum, is secured as an image data developing memory area when the available space exists. As such, after each memory area is secured, the print data is analyzed. The print data is analyzed even when the image data developing memory area is not secured.

### CROSS REFERENCE TO RELATED APPLICATION

This application claims priority from Japanese Patent Application No. 2004-307946, filed on Oct. 22, 2004, the entire subject matter of which is incorporated herein by reference.

### TECHNICAL FIELD

Aspects of the invention relate to a printing apparatus which analyzes input print data and develops it as image data, and a program for controlling the printing apparatus.

### BACKGROUND

In general, a page printer has been known, which analyzes input print data described with page description language (hereinafter, simply referred to as ‘PDL data’), develops it as image data on the basis of the analyzed result, and creates page data corresponding to an amount of one page to print it.

Such page printer requires memory areas for analyzing the input PDL data and for developing the image data, respectively. In addition, for a printer for performing various printing processes using the memory areas, a technique has been known which fixes various memory areas such as a page memory area storing document data input from a host, a bitmap area or the like in advance (for example, see JP-A-11-136459 (FIG. 8)).

### SUMMARY

However, when a predetermined area in the entire memory is fixed as a memory area for analyzing the PDL data or developing the image data, the predetermined memory area cannot be used for other process, so that a memory capacity for other process other than the PDL data process may not be sufficiently secured.

In recent years, a multi-function machine having an image scanner function, a copy function, and a facsimile function together with a printer function has been spread. However, the multi-function machine is constructed such that the same memory (RAM) is commonly used for all of the various functions or a memory area is allocated for each function, and a plurality of functions can be simultaneously executed.

For this reason, if 2 MB is secured in advance for the printer function in a RAM of 6 MB, even though a user views the entire capacity as 6 MB, only 4 MB can be used for other functions other than the printer function, which causes inconvenience to the user. Alternatively, when the memory area is not limited to the printer function but a memory area is fixedly allocated to each function of the multi-function machine, memory areas which can be freely used becomes reduced, which adversely affects the operation of each function in some cases.

The invention provides a printing apparatus that is constructed to analyze print data and develop it as image data and effectively uses a memory therein.

A first aspect of the invention provides a printing apparatus including: an analyzing unit that analyzes input print data; an image data developing unit that develops image data in accordance with the analyzed result by the analyzing unit; a recording unit that records an image on a recording medium on the basis of the image data developed by the image data developing unit; a memory that is used for the analysis of the print data by the analyzing unit and the development of the image data by the image data developing unit; a first capacity availability determining unit that determines whether a first capacity required for analyzing the print data is available in the memory when the print data is input; and an analyzing memory area securing unit that secures an analyzing memory area corresponding to the first capacity in the memory when it is determined by the first capacity availability determining unit that the first capacity is available. In addition, the analyzing unit executes the analysis of the print data using the analyzing memory area when the analyzing memory area is secured by the analyzing memory area securing unit.

That is, any area in the memory is not secured (fixed) in advance as the analyzing memory area. Alternatively, when the print data need to be analyzed after the print data is input, it is determined whether an available space corresponding to the first capacity required for the analysis exists, and a memory area corresponding to the first capacity is secured as the analyzing memory area when the available space exists.

Therefore, according to the printing apparatus having the above-mentioned structure, the memory area to be secured in the memory in advance becomes reduced as compared with a case of continually securing the analyzing memory area without depending on whether the print data needs to be analyzed as in the related art, so that the memory can be effectively used.

Preferably, the printing apparatus further includes a second capacity availability determining unit that determines whether a second capacity required for developing the image data is available in the memory when the analyzing memory area is secured by the analyzing memory area securing unit; and a developing memory area securing unit that secures a developing memory area corresponding to the second capacity in the memory when it is determined by the second capacity availability determining unit that the second capacity is available. In addition, the image data developing unit develops the image data on the developing memory area secured by the developing memory area securing unit.

In the printing apparatus having the above-mentioned structure, the analyzing memory area is not secured from the start and the developing memory area is not secured from the start. If necessary, that is, when the print data is input and the analyzing memory area is secured, it is determined whether an available space corresponding to the second capacity required for developing the image data exists. In addition, a memory area corresponding to the second capacity is secured as the developing memory area when the available space exists.

Therefore, in the printing apparatus having the above-mentioned structure, the developing memory area is not fixedly secured from the start. Alternatively, it is secured when an available space exists, if necessary, so that the memory can be effectively used.

Preferably, after the analyzing memory area is secured by the analyzing memory area securing unit, the analyzing unit analyzes the print data even when it is determined by the second capacity availability determining unit that the second capacity is not available in the memory. That is, even when the developing memory area cannot be secured, the print data can be analyzed using the analyzing memory area which has already been secured.

As such, according to the printing apparatus having the above-mentioned structure, the print data is analyzed even when the developing memory area cannot be secured, so that process for the input print data can be carried out. As a result, it is possible to increase the printing process speed.

In addition, when it is determined by the second capacity availability determining unit that the second capacity is available, it may be assumed that an available capacity larger than the second capacity exists. Preferably, when it is determined that the second capacity is available by the second capacity availability determining unit, the developing memory area securing unit secures as the developing memory area the maximum capacity which can be secured for developing the image data in the memory.

That is, when the available space corresponding to the second capacity exists, the available space corresponding to the second capacity is not secured as the developing memory area, and the maximum capacity, which is not less than the second capacity and is secured as the image data developing area, is secured. Accordingly, the larger the available capacity is, the larger the capacity larger than the second capacity can be secured as the developing memory area. In contrast, when only an available space corresponding to the second capacity exists, the second capacity is secured as the developing memory area.

Therefore, according to the printing apparatus having the structure, the image data developing memory area can be maximally secured, so that a time taken for developing the image data can be decreased.

In addition, even when the developing memory area is secured by the developing memory area securing unit, all of the image data to be the developed subject may not be developed in accordance with a capacity of the secured developing memory area. In this case, it is necessary to wait until the area for developing the remaining image data becomes available after developing the image data on the developing memory area such that the development can be executed right after the area becomes available.

The printing apparatus further includes a development state determining unit that determines whether all the image data to be developed is developed after the image data developing unit develops the image data on the developing memory area; a third capacity availability determining unit that continuously determines whether a third capacity for developing remaining data to be the image data which is not developed is available in the memory until the corresponding third capacity becomes available, when it is determined by the development state determining unit that all the image data is not developed; and a remaining data developing memory area securing unit that secures a remaining data developing memory area corresponding to the third capacity in the memory when it is determined by the third capacity availability determining unit that the third capacity is available. The image data developing unit develops the remaining data on the remaining data developing memory area when the remaining data developing memory area is secured by the remaining data developing memory area securing unit.

According to the printing apparatus having the structure, even when a sufficient developing memory area cannot be secured from the start, development can be executed in a memory area which has been secured. After that, the short memory area is secured as the remaining data developing memory area when the available capacity is generated, and the remaining data is developed thereon. Accordingly, development of the image data can be effectively executed, so that it is possible to increase an overall speed of the print process.

In addition, when the image data to be developed remains after the image data is developed on the remaining data developing memory area, the process enters a standby mode until the memory area corresponding to the third capacity becomes available. When the memory area corresponding to the third capacity is available, the memory area may be secured as a new remaining data developing memory area, so that the remaining image data may be developed. That is, the remaining data developing memory area securing unit repeatedly secures the remaining data developing memory area (corresponding to the third capacity) until all of the image data to be developed is developed in the memory.

In addition, after the analyzing memory area is secured, the developing memory area may not be secured due to the second capacity which is not available in accordance with a state of the available memory space. Preferably, the printing apparatus further includes a storage medium that is formed so as to be separate from the memory and is capable of rewriting data; a storage medium determining unit that determines whether an available capacity for storing the image data exists in the storage medium when it is determined by the second capacity availability determining unit that the second capacity is not available in the memory; and a temporary storing area securing unit that secures the available capacity as a temporary storing area when it is determined by the storage medium determining unit that the available capacity exists. In addition, the image data developing unit develops the image data on the temporary storing area when the temporary storing area is secured by the temporary storing area securing unit.

That is, even when the developing memory area corresponding to the second capacity cannot be secured, the process does not enter a standby mode which waits until the memory becomes available and does not execute the development, but the image data is stored in the storage medium separated from the memory. In this way, the development process can be executed even when the developing memory area cannot be secured in the memory, and the analyzing unit can analyze the print data which is newly input. Accordingly, it is possible to increase the print processing speed.

As such, when the image data can be stored in the storage medium, a fourth capacity availability determining unit may continuously determine whether a fourth capacity for storing the imaged data is available in the memory until the corresponding fourth capacity becomes available after the image data is developed on the temporary storing area by the image data developing unit, a redeveloping memory area securing unit may secure the redeveloping memory area corresponding to the fourth capacity in the memory when the fourth capacity availability determining unit determines that the fourth capacity is available, and a redeveloping unit may redevelop the image data developed in the storage medium on the redeveloping memory area when the redeveloping memory area is secured by the redeveloping memory area securing unit. In this case, the recording unit may record an image on the recording medium on the basis of the redeveloped image data when the image data, which is developed on the temporary storing area in the storage medium by the image data developing unit, is redeveloped on the redeveloping memory area by the redeveloping unit.

In addition, redevelopment of the image data on the redeveloping memory area from the storage medium may be carried out on all of the image data at one time, or may be carried out over several times whenever the redeveloping memory area corresponding to a predetermined capacity is secured, and may employ various methods so long as all of the image data of the storage medium is completely redeveloped on the memory.

In this case, the image data developing unit may carry out the image data development on the temporary storing area in the storage medium by means of compression and storage of the image data, and the redeveloping unit may restore the image data stored in the temporary storing area in a compressed state as original image data and develop it on the redeveloping memory area.

As such, by compressing the image data and storing it in the storage medium, the image data to be stored can be surely stored even when a sufficient available capacity does not exist in the storage medium. In other words, the image data can be stored in a compressed state, so that it is possible to reduce the load of the available capacity of the storage medium.

In this case, when the developing memory area is secured for developing the image data, the developing memory area may be opened by the development area opening unit after the image data developed on the area is recorded by the recording unit. As such, by opening the memory area where the image data is developed after the image data is recorded, the opened area can be effectively used again for other functions.

In addition, in this case, the development area opening unit may open an area where the image data corresponding to an image of one page is developed in the memory whenever the image of one page is recorded by the recording unit. In this way, the area can be continuously opened per page without waiting for the completion of one printing job (image recording), so that the memory area can be opened quickly, which allows the memory to be effectively used.

In addition, the printing apparatus may further include an analysis area opening unit which opens the analyzing memory area secured for analysis after the analysis of the print data is completed by the analyzing unit, so that the memory can be more effectively used.

In this case, the analysis area opening unit may open the analyzing memory area right after the data analysis is completed by the analyzing unit, but the analysis area opening unit may open the analyzing memory area when predetermined conditions are met after the analysis is completed.

In addition, at least one of the conditions is that an available capacity in the memory is not more than a predetermined opening capacity.

By setting an opening timing of the analyzing memory area as described above, since the analyzing memory area is continuously secured under a predetermined condition even after the analysis is completed, when the print data is input again, the analyzing memory area securing unit can analyze the print data at a high speed using the secured analyzing memory area without securing the analyzing memory area again. In particular, by setting the opening conditions, the memory area can be opened when there is a short of a memory, so that a disadvantage due to the memory shortage can be prevented.

In the meantime, there are some kinds of print data, which include PDL data described by the PDL, or data similar to an image, so-called dumb data. In a case of the PDL data, an intermediate processing result of the PDL analysis is stored in the memory as an intermediate data during the analysis. Accordingly, in addition to a memory area required for the analysis itself, a memory area for storing the intermediate data is required, so that memory areas are further required as compared with a case of the dumb data.

Accordingly, when the above-mentioned printing apparatus is constructed such that the print data is data described by the PDL, the analyzing unit analyzes the print data to create intermediate data, and the image data developing unit develops the image data in accordance with the intermediate data, it is the printing apparatus which requires more memory areas and effectively uses the memory. It is possible to prevent negative results for the other processes, which leads to better efficiency.

In addition, as described above, in the multi-function machine having other functions in addition to the printer function, the same memory is commonly used by various functions, or the memory area is allocated for each function, which thus leads to a memory shortage as compared with the printing apparatus having only the printer function.

Accordingly, the printing apparatus has at least one function between a facsimile function that temporarily stores image data received through a communication line in the memory and records the image data on the recording medium, and an image reading function that reads out the image by means of an image reading unit and temporarily stores the read image data in the memory. If the printing apparatus has the above-mentioned structure, even when the printing apparatus is a multifunctional type having the facsimile function or the image reading function, the memory can be effectively used, which leads to better efficiency.

According to a second aspect of the invention, there is provided a program for achieving functions of analyzing print data and developing the analyzed print data to image data using a memory in a computer, the program making the computer serve as: a first capacity availability determining unit that determines whether a first capacity required for analyzing the print data is available in the memory when the print data is input; an analyzing memory area securing unit that secures an analyzing memory area corresponding to the first capacity in the memory when it is determined by the first capacity availability determining unit that the first capacity is available; an analyzing unit that analyzes the print data using the analyzing memory area when the analyzing memory area is secured by the analyzing memory area securing unit; and an image data developing unit that develops the image data on the memory in accordance with the analyzed result by the analyzing unit.

Accordingly, by means of the program, the computer can operate as the above-mentioned printing apparatus (except for the recording unit).

In addition, the program further makes the computer serve as: a second capacity availability determining unit that determines whether a second capacity required for developing the image data is available in the memory when the analyzing memory is secured by the analyzing memory area securing unit; and a developing memory area securing unit that secures a developing memory area corresponding to the second capacity in the memory when it is determined by the second capacity availability determining unit that the second capacity is available. In addition, the image data developing unit develops the image data on the developing memory area when the developing memory area is secured by the developing memory area securing unit.

Accordingly, by means of the program, the computer can operate as the printing apparatus (except for the recording unit).

In addition, the program may be stored in a ROM or a backup RAM and the ROM or the backup RAM may be built in the computer. Alternatively, the program may be recorded in a recording medium, such as a floppy disk (registered trademark), an optical magnetic disk, a CD-ROM, a hard disk, and so forth, which can be read by a computer, and then may be loaded to the computer and executed, if necessary.

### BRIEF DESCRIPTION OF THE DRAWINGS

Illustrative aspects of the invention may be more readily described with reference to the accompanying drawings:

FIG. 1 is a block diagram illustrating a schematic structure of a printing system according to an embodiment;

FIGS. 2A and 2B are diagrams illustrating a specific example of a memory management area;

FIG. 3 is a flow chart illustrating a received data process according to a first embodiment;

FIG. 4 is a flow chart illustrating an image data development process of step S200 in the received data process of FIG. 3 in detail;

FIG. 5 is a flow chart illustrating a printing process according to the first embodiment;

FIG. 6 is a flow chart illustrating an image data development process according to a second embodiment; and

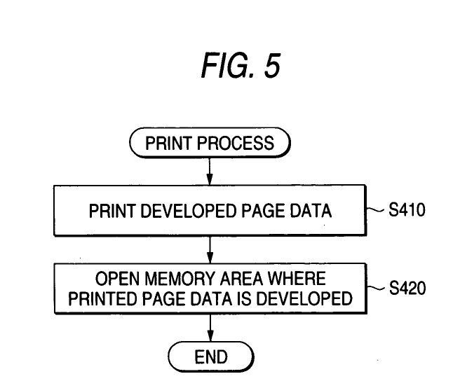

FIG. 5 is a flow chart illustrating a printing process according to a second embodiment.

### DETAILED DESCRIPTION

Hereinafter, preferred embodiments of the invention will be described with reference to the accompanying drawings.

### First Embodiment

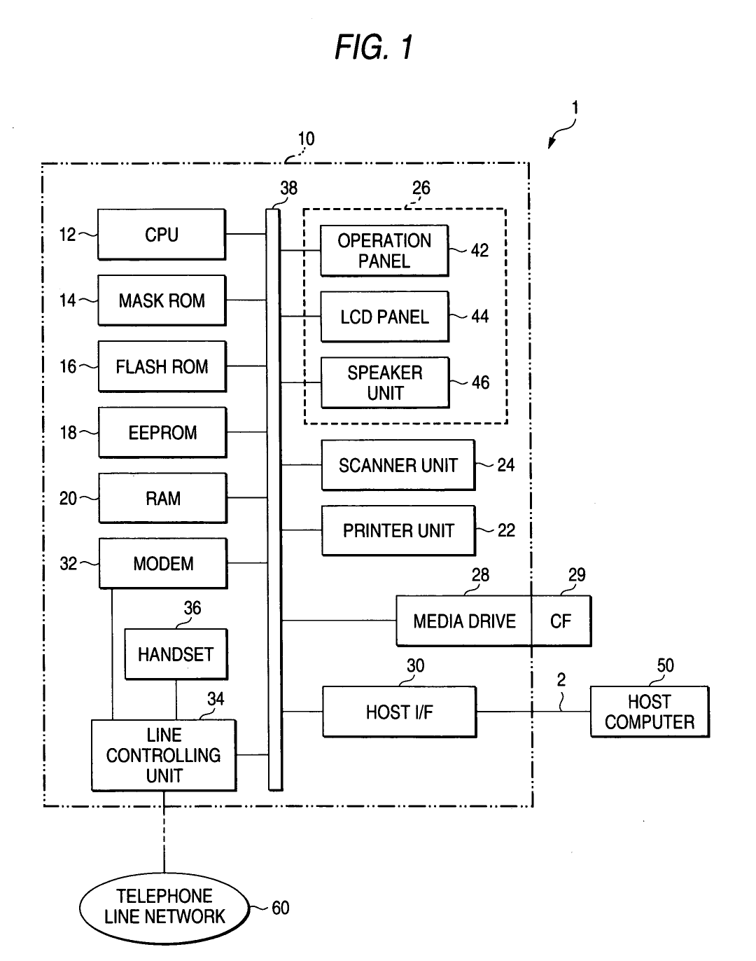

FIG. 1 is a block diagram illustrating a schematic structure of a printing system 1 of the present embodiment. As shown in FIG. 1, in the printing system 1 of the present embodiment, a multi-function machine 10 to which a printing apparatus of the invention is applied, and a host computer 50 (hereinafter, simply referred to as ‘host’) are connected to each other such that data is exchanged through a communication cable 2 (communication line of the invention).

The multi-function machine 10 has a telephone function of achieving a telephone conversation through a telephone line network 60, a scanner function of reading out an image of a sheet as image data (image reading function), a printer function of printing the image displayed as the image data on the sheet, a facsimile function of transmitting or receiving the image through the telephone line network 60 and of temporarily storing the received image data in a memory (such as a RAM 20) and then printing it on the sheet (recording it on the recording medium), and so forth.

In addition, in the multi-function machine 10, a CPU 12, a mask ROM 14, a flash ROM 16, an EEPROM 18, a RAM 20, a printer unit 22, a scanner unit 24, a user interface 26, a media drive 28, a host interface 30, a modem 32, a line controlling unit 34, or the like are connected to each other through a bus 38. Further, the line controlling unit 34 is connected to a handset 36.

The CPU 12 controls the overall operation of the multi-function machine 10 by sending an instruction to each of constituent elements of the multi-function machine 10 through the bus 38 while making the processed result stored in the RAM 20 in accordance with various program and data stored in the mask ROM 14 or the flash ROM 16.

The mask ROM 14 is a widely well known ROM where stored contents cannot be rewritten, and programs or data, such as a boot program for driving the multi-function machine 10, font data used for the printer function, or the like, which are hardly likely to be rewritten, are stored in the mask ROM 14.

The flash ROM 16 is a well known ROM where stored contents can be rewritten, and a program for analyzing print data transmitted from the host 50, various programs or data for achieving the above-described various functions, or the like are stored in the flash ROM 16.

The EEPROM 18 is also a well known non-volatile memory where stored contents can be rewritten, and control parameters required when the CPU 12 executes various processes, and various information, such as telephone numbers, facsimile numbers or the like registered by a user input, are stored in the EEPROM 18.

The RAM 20 corresponds to the memory of the invention. The RAM 20 is a well-known volatile memory which can hold stored contents during only a period for which a power is supplied thereto, and is used as a work area when the CPU 12 executes various processes.

The printer unit 22 corresponds to a recording unit of the invention, and receives an instruction from the CPU 12 and carries out image printing on the sheet (image recording on the recording medium) set in a feed unit (not shown).

The scanner unit 24 corresponds to an image reading unit, and receives an instruction from the CPU 12 and then reads out the image on the sheet from the sheet set in a reading unit (not shown) to create image data of the read image.

In addition, the multi-function machine 10 has also a so-called copy function which prints the image read out through the scanner unit 24 in the printer unit 22.

The user interface 26 has an operation panel 42 composed of a plurality of operation buttons allowing characters, numeric characters, symbols or the like to be input, a display panel (LCD panel) 44 that receives instructions from the CPU 12 and displays various information, and a speaker unit 46 composed of a speaker and a driver circuit for driving the speaker.

The host interface 30 is an interface for connecting the multi-function machine 10 to a separate computer system through a communication cable. In the present embodiment, the multi-function machine 10 and the host 50 are connected to each other through the communication cable 2, as described above.

The modem 32 receives an instruction from the CPU 12 and modulates the image data created by the scanner unit 24 to generate an image signal transmitted through the telephone line network 60. In addition, the modem 32 demodulates the image signal input from the telephone line network 60 through the line controlling unit 34 to create image data. In addition, the handset 36 is a transceiver that is detachable from the main body of the multi-function machine 10.

The line controlling unit 34 allows various signals to be input from the telephone line network 60 and to be output to the telephone line network 60, and receives an instruction from the CPU 12 and sets a transfer path composed of a transmitting destination and a transmitting source of each signal input and output between the telephone line network 60 and the line controlling unit 34.

The media drive 28 is a device that allows various memory cards 29 to be attachable thereto or detachable therefrom and carries out data recording and reading on the mounted memory card 29. In addition, the ‘memory card’ referred herein indicates, for example, a compact flash (registered trademark; hereinafter, simply referred to as ‘CF’), a smart media (registered trademark), a memory stick (registered trademark), a multimedia card, an SD memory card, and so forth. In addition, in the present embodiment, it is assumed that the CF 29 (corresponding to a storage medium) is inserted into the media drive 28.

The host 50 is a well-known computer system composed of a CPU, a ROM, a RAM, a hard disk, a keyboard, a mouse, a display, and so forth, which are not shown in the drawing. In addition, a scanner program used for the scanner function in the multi-function machine 10, a printer driver used for the printer function in the multi-function machine 10 or the like, in addition to various application software, are stored in a hard disk included in the host 50.

The printing system 1 according to the present embodiment is constructed such that PDL data described by a page description language (PDL) is transmitted to the multi-function machine 10 as print data from the host 50. That is, in the host 50, the user uses various application software, so that image data created by the application software is converted into the PDL data by the printer driver and is then transmitted to the multi-function machine 10.

In addition, in the multi-function machine 10, when the PDL data is received from the host 50, by means of the process of the CPU 12 on the basis of a PDL reception processing program stored in the flash ROM 16, securing the memory area required for analyzing the PDL data, securing the memory area required for developing image data, analysis on the PDL data, creation of intermediate data based on the analyzed result, development to the image data based on the intermediate data, or the like, which are described in detail below, are carried out.

In addition, the multi-function machine 10 itself can receive and process not only the PDL data but also GDI data of an image type (also referred to as dumb data) as print data. For this reason, when the host 50 is constructed to create and transmit the GDI data, the multi-function machine 10 can carry out printing on the basis of the GDI data.

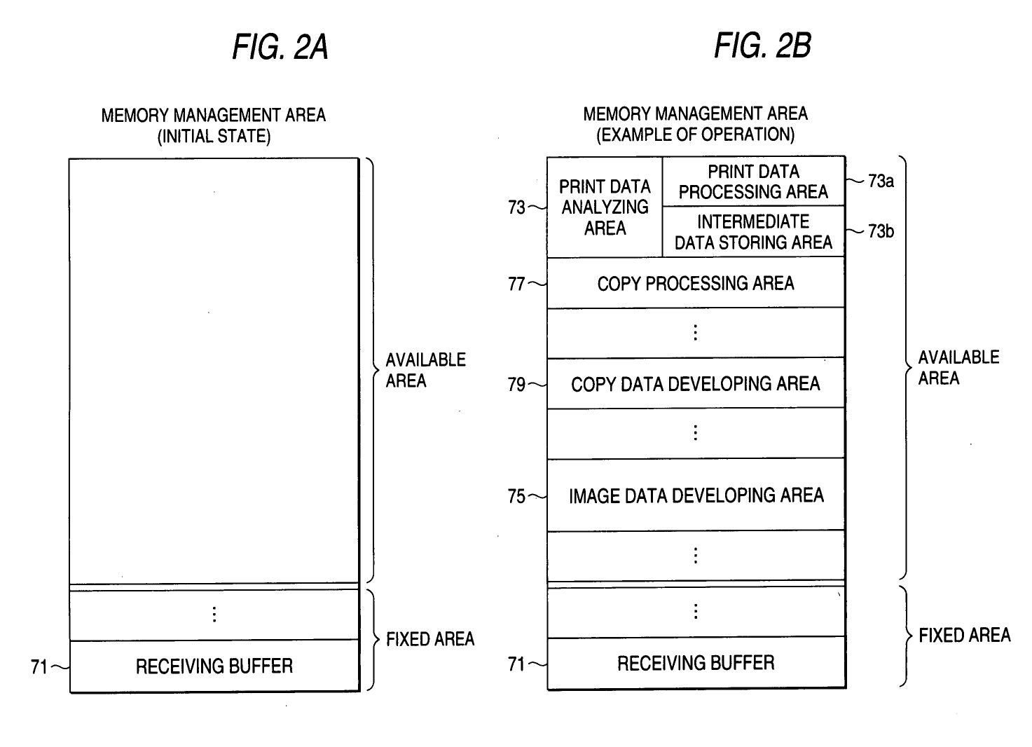

In this case, a memory management area of the multi-function machine 10 of the present embodiment will be described with reference to FIG. 2. The multi-function machine 10 includes the RAM 20 having a capacity of 8 MB. In addition, as shown in FIG. 2(a), a portion (for example, about 0.5 MB) of the entire memory management area (8 MB) is secured in advance as a predetermined dedicated and fixed area. The other area are not fixed but set as an available area that can be freely used for various functions of the multi-function machine 10.

In addition, the fixed area is a previously secured area at the minimum, including an area that is previously secured for the receiving buffer 71 when receiving data from the host 50 and an area that is used in some of copy functions.

Further, after a power is supplied to the multi-function machine 10 and the multi-function machine 10 starts to operate, for example, when the PDL data is transmitted from the host 50 while the copy function is carried out, memory areas required for carrying out the respective functions are secured in the available area, as shown in FIG. 2(b). FIG. 2(b) shows an example in which a print data analyzing memory area 73 and an image dada developing memory area 75 are secured for the printer function, and a copy processing memory area 77 and a copy data developing memory area 79 are secured for the copy function.

Among these areas, the print data analyzing memory area 73 is a memory area used for analyzing the print data such as PDL data and generating intermediate data, and has a print data processing memory area 73a for carrying out a receiving process and an analysis process for the print data and an intermediate data storing memory area 73b where the intermediate data is created and stored.

The intermediate data is data in which intermediate results during the PDL data analysis are displayed per page, and are used for clearly carrying out desired rendering on a desired place of the page. In addition, the image data is developed on the image data developing memory area 75 on the basis of the intermediate data.

In addition, in a case of the GDI data, the intermediate data is not created while the GDI data is analyzed and developed on the image data developing memory area 75. Accordingly, when the GDI data is received, the intermediate data storing memory area 73b shown in FIG. 2(b) is not secured.

In addition, if the operation of the printer function is completed by the completion of receiving the PDL data and the completion of the print output from the state shown in FIG. 2(b), the print data analyzing memory area 73 and the image data developing memory area 75, which have been secured until the operation of the printer function is completed, are opened, and other functions become available. In addition, details of the timing at which the print data analyzing memory area 73 and the image data developing memory area 75 are opened will be described below.

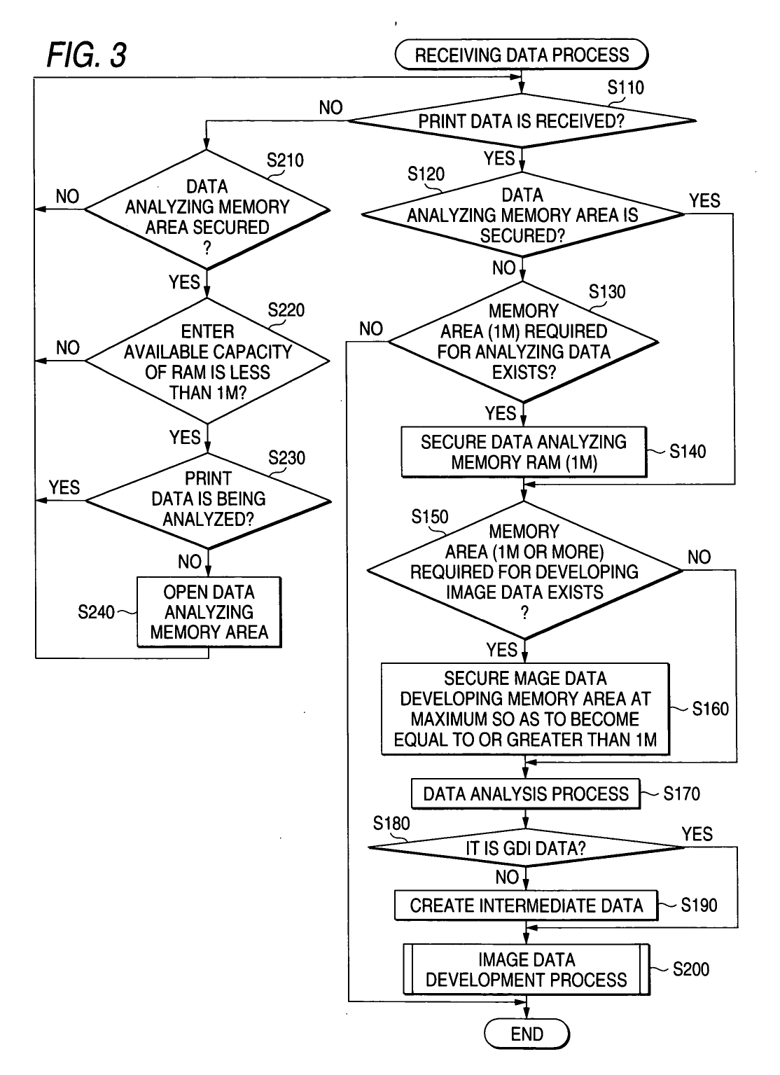

Next, the received data process, which is carried out in the multi-function machine 10 when print data (for example, PDL data) is received from the host 50, will be described with reference to FIG. 3. FIG. 3 is a flow chart illustrating the received data process carried out by the CPU 12. In the multi-function machine 10, the CPU 12 reads the received PDL processing program from the flash ROM 16, and the received data is processed in accordance with the received PDL processing program. The received data process is carried out when data is received while the multi-function machine 10 carries out polling at a predetermined interval. In addition, the following description will be given with reference to FIG. 2(b).

If data is received from the host 50, first, it is determined whether the received data is print data (PDL data or GDI data) (S110). At this time, in a case of NO, the process proceeds to step S210, and in a case of YES (S110: YES), it is determined whether the print data analyzing memory area 73 is secured (S120). Next, in a case of YES, the process proceeds to step S150, but in a case of NO, it is determined whether the preset capacity (in the present embodiment, 1 MB) as a memory area required for analyzing the print data is available in the RAM 20 (in particular, in an available area of the RAM 20) (S130). In addition, the ‘1 MB’ as a threshold value in the process of step S130 corresponds to a first capacity of the invention.

In addition, when the available capacity of 1 MB does not exist, it is determined that the print data analyzing memory area 73 cannot be secured, and the received data process is completed as it is. In contrast, when the available capacity of 1 MB exists (S130: YES), the available capacity of 1 MB is secured as the print data analyzing memory area 73 (S140).

After the print data analyzing memory area 73 is secured, it is subsequently determined whether a preset capacity (in the present embodiment, 1 MB or more) as a memory area required for developing the image data is available (S150). In addition, the ‘1 MB’ as a threshold value in the process of S150 corresponds to a second capacity of the invention.

In addition, when an available capacity of 1 MB or more exists (S150: YES), a maximum capacity, which is not less than 1 MB and can be secured for developing the image data, is secured as the image data developing memory area 75 (S160). Next, the print data is analyzed using the print data analyzing memory area 73 which is already secured (S170).

In the meantime, even when the available capacity of 1 MB or more does not exist (S150: NO), the print data is analyzed using the print data analyzing memory area 73 which is already secured (S170) while the image data developing memory area 75 cannot be secured.

After the data analysis process is completed, it is determined whether the received print data is GDI data (S180). In a case of the PDL data, intermediate data is created (S190), and the image data development process is executed (S200). In a case of the GDI data, the process directly proceeds to the image data development process.

That is, according to the multi-function machine 10 of the present embodiment, even when the image data developing memory area cannot be secured, the print data analyzing process and the process of creating and storing the intermediate data on the intermediate data storing memory area 73b are carried out.

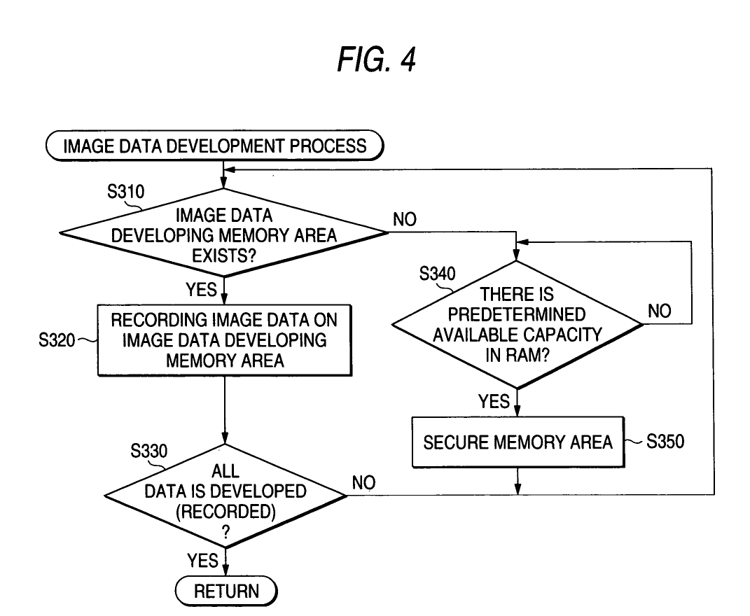

FIG. 4 illustrates the image data developing of step S200 in detail. In the present process, first, it is determined whether the image data developing memory area is secured (S310). In addition, when the image data developing memory area 75 is secured in the above-described process of S160 or when the image data developing memory area is secured in the process of S350 to be described in detail below (S310: YES), the image data is written (developed) in the secured memory area (S320). The writing (development) of the image data is carried out in accordance with the intermediate data created in step S190 when the print data is PDL data.

After the development process of step S320, it is determined whether all the image data corresponding to one page to be developed is completely developed (S330), and in a case of YES, the received data process for the corresponding page is completed, and the received data process of FIG. 3 is repeated until the receiving of the print data is completed. In the meantime, in a case of NO (S330: NO) due to a small capacity of the image data developing memory, the process returns to S310. In this case, the remaining image data, which is not developed, corresponds to remaining data of the invention.

When the process returns to S310 after it is determined that all the image data corresponding to one page is not developed in step S330, the image data developing memory area is not secured. Accordingly, the process proceeds to S340 and waits until an available space corresponding to a predetermined capacity (for example, 128 KB) becomes exist in the RAM 20. In addition, in a case in which the operation of other function is completed, the corresponding memory is opened, and the available capacity of 128 KB becomes exist (S340: YES), the available capacity of 128 KB is secured as the image data developing memory area (S350). The memory area secured in the process of step S350 corresponds to the remaining data developing memory area of the invention, and the capacity of ‘128 KB’ corresponds to the third capacity of the invention.

As such, if the memory area is secured in step S350, a positive determination is given in the process of step S310, so that the image data is developed on the secured memory area (S320). As a result, when all of the image data to be developed is developed, the received data process for the corresponding page is completed, however, when the image data, which is not developed, still remains, the developing memory area corresponding to 128 KB is repeatedly secured along the flow of S310→S340→S350 as is done above.

The receiving process will be described with reference to FIG. 3 again. When the reception of the print data is completed and data other than the print data is received from the host 50, a negative determination is given in the determination process of S110, so that the process proceeds to S210 and it is determined whether the print data analyzing memory area 73 is secured. In this case, when the memory area is already opened and is not secured, the process returns to S110. However, for example, when the print data analyzing memory area 73 is secured right after the print process is completed (S210: YES), it is determined whether the total available capacity of the RAM 20 is less than 1 MB (S220).

In this case, when total available capacity of the RAM 20 is not less than 1 MB, the process returns to S110, but when it is less than 1 MB (S220: YES), it is then determined whether the print data is being analyzed. In a case of YES, the process returns to S110, and in a case of NO (S230: NO), the secured print data analyzing memory area 73 is opened (S240).

That is, the print data analyzing memory area 73 is opened when conditions are met that the print data is not received and is not being analyzed, and the available capacity of the RAM 20 is less than 1 MB. The reason why the print data analyzing memory area is not immediately opened is to prevent the print data processing speed from decreasing. That is, if the print data analyzing memory area 73 is opened whenever the print data analysis is completed for each page, it takes much time till the process of S170 starts. In addition, the capacity of ‘1 MB’, which serves as a determination reference in the determination process of S220, corresponds to the opening capacity in the invention.

In the meantime, if the image data corresponding to one page (hereinafter, referred to as ‘page data’) is developed in the image data developing memory area 75, the print process illustrated in FIG. 5 is carried out for every page. The print process of FIG. 5 is executed with a multitasking process together with the received data process of FIG. 3 (and FIG. 4) by executing a print processing program stored in the flash ROM 16 by the CPU 12. If the page data is developed in the image data developing memory area 75, the developed page data is printed by the printer unit 22 (S410). In addition, in the image data developing memory area 75, a memory area where the printed page data is developed is opened (S420).

According to the multi-function machine 10 of the present embodiment as described above, the print data analyzing memory area and the image data developing memory area are not fixedly secured, but are secured when an available space exists, if necessary. Consequently, the memory areas are not fixedly secured from the beginning, so that they can be effectively used for processes other than the print data analyzing process or functions other than the printer function. In addition, such effective use allows the entire capacity of the RAM 20 to be reduced, which leads to a decrease in a cost of the RAM 20 and further leads to a decrease in an entire cost of the multi-function machine 10.

In addition, even when the image data developing memory area cannot be secured, the print data analyzing process can be performed, so that the process can be carried out on the print data by that extent, which allows the entire speed of the print process to increase. In addition, reduced are cases that even the print data cannot be analyzed due to a memory state in which an available space does not exist, which enhances convenience for the user to use it.

In addition, the image data developing memory area can secure a memory capacity at the maximum so as to be not less than 1 MB, so that a time taken for developing the image data can be decreased.

In addition, the image data developing memory area does not wait for the completion of the whole printing (image writing) of one printing job, but is opened per page whenever the printing process corresponding to one page is completed, so that the memory area can be opened at a high speed. Therefore, it is possible to further effectively use the memory (RAM (20)).

In the meantime, the print data analyzing memory area is smaller than the image data developing memory area, so that the print data analyzing memory area is not immediately opened, but is opened after the above-mentioned predetermined conditions are met. Accordingly, when the print data is input again while print data analyzing memory area is continuously secured, another print data analyzing memory area securing process is not carried out, but the print data analyzing memory area is used which has been continuously secured, so that the analysis of the print data can be quickly initiated.

In addition, in the received data process of FIG. 3, the process of S130 corresponds to the process carried out by the first capacity availability determining unit of the invention, the process of S140 corresponds to the process carried out by the analyzing memory area securing unit of the invention, the process of S150 corresponds to the process carried out by the second capacity availability determining unit of the invention, the process of S160 corresponds to the process carried out by the developing memory area securing unit of the invention, the process of S170 corresponds to the process carried out by the analyzing unit of the invention, the process of S200 corresponds to the process carried out by the image data developing unit of the invention, and the process of S240 corresponds to the process carried out by the analysis area opening unit of the invention.

In addition, in the image data development process of FIG. 4, the process of S330 corresponds to the process carried out by the development state determining unit of the invention, the process of S340 corresponds to the process carried out by the third capacity availability determining unit of the invention, and the process of S350 corresponds to the process carried out by the remaining data developing memory area securing unit of the invention. In addition, the process of S420 in the print process of FIG. 5 corresponds to the process carried out by the development area opening unit of the invention.

### Second Embodiment

In the first embodiment, when the image data developing memory area 75 cannot be secured in the processes of S150 and S160 in the received data process (see FIG. 3), the analysis of the print data is first carried out on the print data analyzing memory area 73. After that, whenever a predetermined available capacity (128 KB in the first embodiment) is generated in the RAM 20, the available capacity is secured as the image data developing memory area, so that the image data is developed.

In contrast, according to the second embodiment, the image data is stored (developed) in the CF 29 instead of the RAM 20 when the image data developing memory area 75 cannot be secured. In addition, at the time of the printing process, the process waits until the available capacity is generated in the RAM 20, secures the available capacity as an image data redeveloping memory area right after the available capacity is generated, stores the image data (page data) developed in the CF 29 (redevelopment), and prints it.

That is, the multi-function machine of the second embodiment is mainly different from the multi-function machine 10 of the first embodiment in that the image data is developed in the CF 29 when the image data developing memory area 75 is not secured at the time of the image data development process of S200 in the received data process of FIG. 3, and the image data is first stored (redeveloped) in the RAM 20 and is then printed when the image data is developed in the CF 29 in the print process.

Accordingly, the multi-function machine of the first embodiment is the same as the multi-function machine 10 of the first embodiment in terms of hardware structure, and the received data process is also the same as the received data process (FIG. 3) of the first embodiment, except for the image data developing process (S200 of FIG. 3). Hereinafter, the difference between the first embodiment and the second embodiment will be mainly described.

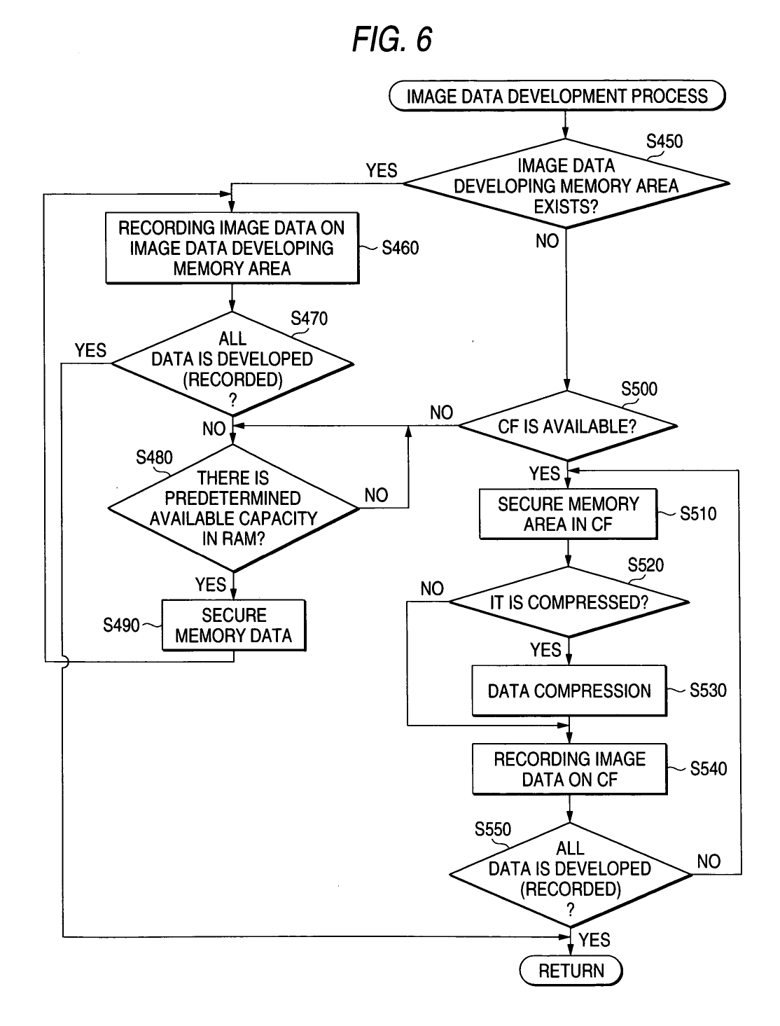

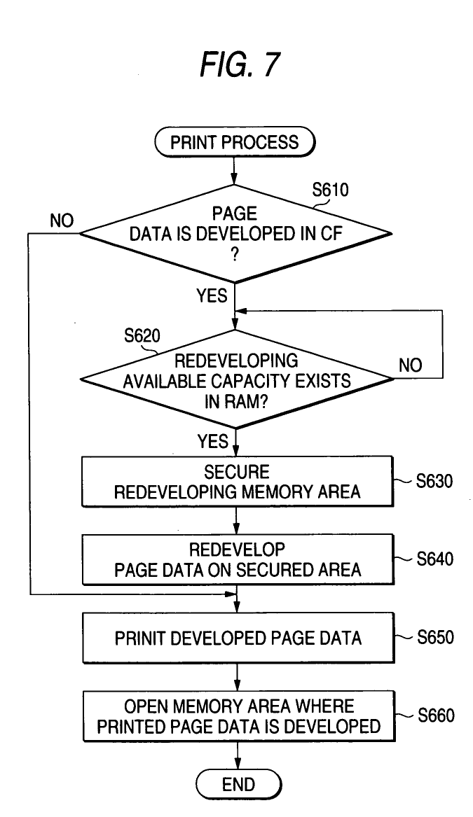

First, FIG. 6 shows the image data development process of the present embodiment. The image data development process is also carried out as the image data development process of S200 of the received data process (FIG. 3) in the present embodiment, and it is first determined whether the image data developing memory area is secured, that is, whether the image data developing memory area 75 is secured in S160 of the received data process (S450). Next, when the image data developing memory area 75 is secured in the process of step S160 (S450: YES), the image data is written (developed) in the secured memory area (S460). The image data writing (development) is also carried out in accordance with the intermediate data created in S190 (see FIG. 3) when the print data is PDL data.

Next, it is determined whether all of the image data corresponding to one page to be developed is developed (S470) after the development process of S460, and when all of the image data is developed, the received data process for the corresponding page is completed, and the received data process of FIG. 3 is repeated until the reception of the print data is completed. In the meantime, when all the image data is not completely developed due to a small capacity of the image data developing memory area (S470: NO), the process waits until an available space corresponding to a predetermined capacity (for example, 128 KB) in the RAM 20 (S480) is generated. In addition, in a case in which operation of other functions is completed, the memory is opened, and the available capacity of 128 KB is generated (S480: YES), the available capacity of 128 KB is secured as an image data developing memory area (S490).

As such, after the memory area is secured in S490, the image data is developed in the corresponding memory area (S460), and it is determined whether all of the image data corresponding to one page to be developed is developed (S470). In addition, the processes, such as S480→S490→S460→S470→S480, are repeated until all of the image data corresponding to one page is developed.

In the meantime, when the image data developing memory area 75 is not secured in S160 of the received data process (FIG. 3), a negative determination is given in S450 of the image data development process, and it is then determined whether the CF 29 is available (S500).

At this time, for example, when the CF 29 is not available due to the fact that nothing is inserted into the media drive 28, a media card other than the CF 29 is inserted, or an available capacity is short in the CF 29 (S500: NO), the process returns to step S480, and waits until an available capacity is generated in the RAM 20.

In the meantime, when the CF 29 is inserted into the media drive and is available (S500: YES), the image data developing memory area is secured in the CF 29 (S510). Next, when the image data developing mode with respect to the CF 29 is set to a compression mode (S520: YES), the image data is compressed and is then written in the CF 29 (S530 and S540). When the image data developing mode with respect to the CF 29 is set to a non-compression mode (S520: NO), the image data is written in the CF 29 as it is (S540).

In addition, the memory area secured in the process of S510 corresponds to the temporary storing area of the invention. Further, the image data developing mode with respect to the CF 29 may select any one mode between the compression mode and the non-compression mode by allowing the user to operate the operation panel 42. Alternatively, a proper development mode may be automatically selected and set in accordance with an available capacity in the CF 29.

After the image data is written in the CF 29, it is determined whether all of the image data corresponding to one page is written in the CF (S550), and the processes of S510 and the following steps are repeated until the image data corresponding to one page is completely written. That is, the image data is developed as page data of a page unit in the CF 29.

As such, when the image data is developed in the CF 29, the developed image data is returned to the RAM 20 and is then printed at the time of the printing process. FIG. 7 illustrates the printing process of the present embodiment. If this print process starts, it is first determined whether page data is developed in the CF 29 (S610), and in a case of YES (S610; YES), the process waits until an image data redeveloping available capacity is available in the RAM 20 (S620). In addition, the image data redeveloping available capacity corresponds to the fourth capacity of the invention.

When the image data redeveloping available capacity is available (S620: YES), a memory area corresponding to the capacity is secured as a redevelopment memory area (S630), and page data of the CF 29 is redeveloped to the secured redevelopment memory area (S640). In this way, when the page data of the CF 29 is redeveloped in the RAM 20, the page data is printed and is then output (S650). After the print output, the memory area where the printed page data is developed, that is, the redevelopment memory area is opened (S660). In addition, if the page data is not stored in the CF 29 at the time of initiating the print process, the process progresses from S610 to S650.

The redevelopment of the page data from the CF 29 to the RAM 20 may secure the memory area corresponding to one page in the RAM 20 so as to complete the redevelopment at one time, or may be sequentially carried out on the RAM 20 per a predetermined capacity (for example, a band unit).

Therefore, according to the present embodiment, even when the image data developing memory area 75 cannot be secured in the processes of S150 to S160 of the received data process (FIG. 3), the process does not enter a standby mode which waits until an available space is generated in the RAM 20, but the image data is made to be stored (developed) in the CF 29 provided separately from the RAM 20. Accordingly, the development of the image data can be carried out even when the image data developing memory area 75 cannot be secured in the RAM 20 itself. Therefore, the print processing speed can be improved.

In addition, since the image data can be compressed and stored in the CF 29, even when a sufficient available capacity does not exist in the CF 29, the image data to be stored can be surely stored. That is, the image data is stored in a compressed state, so that it is possible to reduce the load of the available capacity of the CF 29.

In addition, in the image data development process of FIG. 6, the process of S500 corresponds to the process carried out by the storage medium determining unit of the invention, and the process of S510 corresponds to the process carried out by the temporary storing area securing unit of the invention. In addition, in the print process of FIG. 7, the process of S620 corresponds to the process carried out by the fourth capacity availability determining unit of the invention, the process of S630 corresponds to the process carried out by the redeveloping memory area securing unit of the invention, and the process of S640 corresponds to the process carried out by the redeveloping unit of the invention.

### Modified Embodiment

In addition, the invention is not limited to the above-described embodiments, but various changes and modifications may be made without departing from the spirit and scope of the invention.

For example, in the second embodiment, the image data is stored in the CF 29, but the image data may be stored in the CF 29 in the intermediate data state. In this way, a capacity of the CF 29 becomes reduced. However, the intermediate data stored in the CF 29 needs to be developed in the RAM 20 after performing the image data development process, so that the print processing speed may be decreased. Accordingly, it is preferable to store the data in the CF 29 in a state in which the image data development process is performed in terms of print processing speed as is described in the second embodiment.

In addition, in the respective embodiments, the invention is applied to the multi-function machine having a plurality of functions including a printer function (that is, printing function). However, the invention is not limited thereto, and may also be applied to a printing apparatus having only a printer function.

In addition, the CF 29 is used as an image data developing storage medium other than the RAM 20 in the second embodiment. However, the storage medium of the invention is not limited to the CF 29. For example, the image data may be stored in other media cards that can be inserted into a media drive 28, or may be stored in a backup RAM (not shown) which operates with a power supplied from a battery (not shown) built in the multi-function machine 10.

What is claimed is:

1. A printing apparatus comprising:
an analyzing unit that analyzes input print data;
an image data developing unit that develops image data in accordance with the analyzed result by the analyzing unit;
a recording unit that records an image on a recording medium on the basis of the image data developed by the image data developing unit;
a memory that is used for the analysis of the print data by the analyzing unit and the development of the image data by the image data developing unit;
a first capacity availability determining unit that determines whether a first capacity required for analyzing the print data is available in the memory when the print data is input; and
an analyzing memory area securing unit that secures an analyzing memory area corresponding to the first capacity in the memory when it is determined by the first capacity availability determining unit that the first capacity is available,
wherein the analyzing unit analyzes the print data using the analyzing memory area when the analyzing memory area is secured by the analyzing memory area securing unit.

2. The printing apparatus according to claim 1, further comprising:
a second capacity availability determining unit that determines whether a second capacity required for developing the image data is available in the memory when the analyzing memory area is secured by the analyzing memory area securing unit; and
a developing memory area securing unit that secures a developing memory area corresponding to the second capacity in the memory when it is determined by the second capacity availability determining unit that the second capacity is available,
wherein the image data developing unit develops the image data on the developing memory area secured by the developing memory area securing unit.

3. The printing apparatus according to claim 2, wherein after the analyzing memory area is secured by the analyzing memory area securing unit, the analyzing unit analyzes the print data even when it is determined by the second capacity availability determining unit that the second capacity is not available in the memory.

4. The printing apparatus according to claim 2, wherein when it is determined by the second capacity availability determining unit that the second capacity is available, the developing memory area securing unit secures as the developing memory area the maximum capacity which can be secured for developing the image data in the memory.

5. The printing apparatus according to claim 2, further comprising:
a development state determining unit that determines whether all the image data to be developed is developed after the image data developing unit develops the image data on the developing memory area;
a third capacity availability determining unit that continuously determines whether a third capacity for developing remaining data to be the image data which is not developed is available in the memory until the corresponding third capacity becomes available, when it is determined by development state determining unit that all the image data is not developed; and
a remaining data developing memory area securing unit that secures a remaining data developing memory area corresponding to the third capacity in the memory when it is determined by the third capacity availability determining unit that the third capacity is available,
wherein the image data developing unit develops the remaining data on the remaining data developing memory area when the remaining data developing memory area is secured by the remaining data developing memory area securing unit.

6. The printing apparatus according to claim 2, further comprising:
a storage medium that is provided so as to be separated from the memory and is capable of rewriting data;
a storage medium determining unit that determines whether an available capacity for storing the image data exists in the storage medium when it is determined by the second capacity availability determining unit that the second capacity is not available in the memory; and
a temporary storing area securing unit that secures the available capacity as a temporary storing area when it is determined by the storage medium determining unit that the available capacity exists,
wherein the image data developing unit develops the image data on the temporary storing area when the temporary storing area is secured by the temporary storing area securing unit.

7. The printing apparatus according to claim 6, further comprising:
a fourth capacity availability determining unit that continuously determines whether a fourth capacity for storing the imaged data is available in the memory until the corresponding fourth capacity becomes available after the image data is developed on the temporary storing area by the image data developing unit;
a redeveloping memory area securing unit that secures a redeveloping memory area corresponding to the fourth capacity in the memory when it is determined by the fourth capacity availability determining unit that the fourth capacity is available; and
a redeveloping unit that redevelops the image data developed in the storage medium on the redeveloping memory area when the redeveloping memory area is secured by the redeveloping memory area securing unit,
wherein the recording unit records an image on the recording medium on the basis of the redeveloped image data when the image data, which is developed on the temporary storing area in the storage medium by the image data developing unit, is redeveloped on the redeveloping memory area by the redeveloping unit.

8. The printing apparatus according to claim 7, wherein the image data developing unit carries out the image data development on the temporary storing area in the storage medium by means of compression and storage of the image data, and
the redeveloping unit restores the image data stored in the temporary storing area in a compressed state as original image data and develops the image data on the redeveloping memory area.

9. The printing apparatus according to claim 2, further comprising:
a development area opening unit that opens an area where the image data is developed after the image data developed in the memory is recorded by the recording unit.

10. The printing apparatus according to claim 9, wherein the development area opening unit opens an area where image data corresponding to an image of one page is developed in the memory whenever the image of one page is recorded by the recording unit.

11. The printing apparatus according to claim 1, further comprising:
an analysis area opening unit that opens the analyzing memory area secured for analysis after the analysis of the print data is completed by the analyzing unit.

12. The printing apparatus according to claim 11, wherein the analysis area opening unit opens the analyzing memory area when predetermined conditions are met after the analysis is completed.

13. The printing apparatus according to claim 12, wherein at least one of the conditions is a condition that an available capacity in the memory is not more than a predetermined opening capacity.

14. The printing apparatus according to claim 1, wherein the print data is data described by a page description language (PDL),
the analyzing unit analyzes the print data to create intermediate data, and
the image data developing unit develops the image data in accordance with the intermediate data.

15. The printing apparatus according to claim 1, wherein the printing apparatus has at least one function between a facsimile function that temporarily stores image data received through a communication line in the memory and records the image data on the recording medium, and an image reading function that reads out the image by means of an image reading unit and temporarily stores the read image data in the memory.

16. A computer readable medium bearing the software instructions enabling a computer to analyze print data and developing the analyzed print data to image data using a memory, the software instructions making the computer function as:
a first capacity availability determining unit that determines whether a first capacity required for analyzing the print data is available in the memory when the print data is input;
an analyzing memory area securing unit that secures an analyzing memory area corresponding to the first capacity in the memory when it is determined by the first capacity availability determining unit that the first capacity is available;
an analyzing unit that analyzes the print data using the analyzing memory area when the analyzing memory area is secured by the analyzing memory area securing unit; and
an image data developing unit that develops the image data in the memory in accordance with the analyzed result by the analyzing unit.

17. The computer readable medium according to claim 16, the software instructions further making the computer function as:
a second capacity availability determining unit that determines whether a second capacity required for developing the image data is available in the memory when the analyzing memory is secured by the analyzing memory area securing unit; and
a developing memory area securing unit that secures a developing memory area corresponding to the second capacity in the memory when it is determined by the second capacity availability determining unit that the second capacity is available,
wherein the image data developing unit develops the image data on the developing memory area when the developing memory area is secured by the developing memory area securing unit.
